(19) United States
(12) Patent Application Publication
(10) Pub. No.: US 2026/0061425 A1
(43) Pub. Date: Mar. 5, 2026

(54) SOCKET-TYPE PCR CARTRIDGE, ROTATIONAL REAL-TIME PCR DEVICE AND OPERATION METHOD BY THE SAME

(71) Applicant: AI BIOTICS CO., LTD., Changwon-si Gyeongsangnam-do (KR)

(72) Inventor: Sang Bae MA, Gyeongsangnam-do (KR)

(21) Appl. No.: 18/873,413

(22) PCT Filed: Jan. 25, 2023
(86) PCT No.: PCT/KR2023/001105

§ 371 Date: Nov. 25, 2025

(30) Foreign Application Priority Data
Aug. 12, 2022 (KR) 10-2022-0101060

(51) Int. Cl. B01L 7/00

(52) U.S. Cl. CPC B01L 7/52; B01L 2300/12; B01L 2300/1805; B01L 2400/0409; B01L 2400/065

(57) ABSTRACT

The present disclosure relates to a socket type PCR cartridge, a rotational real time PCR device having the same and an operation method of a rotational real time PCR device having a socket type PCR cartridge. More specifically, the present disclosure relates to a socket type PCR cartridge in which the PCR cartridge is located in a direction of centrifugal force in which an interface module rotates such that DNA mixture solution can be easily injected by the centrifugal force, and the shape of the PCR cartridge is hexahedral such that it can be in close contact with a heating block, a rotational real time PCR device having the same and an operation method of a rotational real time PCR device having a socket type PCR cartridge.

### CROSS-REFERENCE TO RELATED APPLICATION

This application is a national stage application of International Patent Application No. PCT/KR2023/001105, filed on Jan. 25, 2023, which claims the priority of Korean Patent Application No. KR1020220101060 entitled “SOCKET TYPE PCR CARTRIDGE, ROTATIONAL REAL TIME PCR DEVICE AND OPERATION METHOD BY THE SAME” filed with the Korea Intellectual Property Office on Aug. 12, 2022, which is incorporated herein by reference in its entirety.

### TECHNICAL FIELD

The present disclosure relates to a socket type PCR cartridge, a rotational real time PCR device having the same and an operation method of a rotational real time PCR device having a socket type PCR cartridge. More specifically, the present disclosure relates to a socket type PCR cartridge in which the PCR cartridge is located in a direction of centrifugal force in which an interface module rotates such that DNA mixture solution can be easily injected by the centrifugal force, and the shape of the PCR cartridge is hexahedral such that it can be in close contact with a heating block, a rotational real time PCR device having the same and an operation method of a rotational real time PCR device having a socket type PCR cartridge.

### BACKGROUND

PCR (Polymerase Chain Reaction) is a technology that amplifies only the targeted region of a DNA sequence using polymerase chain reaction. The process of PCR includes following three steps. The principle of the polymerase chain reaction is to amplify the desired DNA segment as this process is repeated continuously. The first is denaturation of DNA, which involves heating to 94° C. to separate double-stranded DNA into single-stranded DNA. The second is annealing of the primers, where the denatured DNA and primers are mixed and lowered in temperature so that the primers bind to their respective complementary template DNA. The third is elongation, which acts on DNA polymerase to elongate the primers. Nowadays, PCR method has been developed into a wider range of application technologies. These applications typically include reverse transcriptase polymerase chain reaction (RT-PCR), which directly amplifies RNA using reverse transcriptase enzymes. In addition, there are various methods such as quantitative PCR (qPCR) or real time PCR, which accurately measure the original amount of DNA or RNA by using the quantitative changes observed while performing PCR by attaching fluorescent substances, as well as high-throughput PCR, which performs numerous PCR reactions simultaneously.

Real time PCR is a technology that monitors and interprets the growth of PCR amplification products in real time. Compared to the conventional PCR method, which identifies PCR amplification products at the end point, real time PCR enables accurate quantification of DNA and RNA, eliminates the need for electrophoresis for quick and easy interpretation, and is less prone to contamination. As a result, real time PCR has now become an essential technology for gene expression analysis and SNP measurement. In real time PCR, PCR amplification products are monitored in real time and quantified in the region where amplification occurs exponentially, allowing accurate quantification based on the amplification rate theory of PCR, unlike the existing technology, reverse transcription PCR.

PCR cartridges in conventional technology have a shape that is orthogonal to the centrifugal force, which can lead to the formation of micro voids when centrifugal force is applied. Voids in the PCR cartridge are detrimental to the PCR reaction because the expansion of vapor pressure at high temperatures can cause deformation of the fluid or scattering of light. In addition, PCR cartridges need to be heated with a heating block for DNA amplification, but PCR cartridges in conventional technology are in the shape of a conical tube, which does not make close contact with a heating block, which is in the shape of a cuboid, leading to poor thermal efficiency.

### SUMMARY

### Technical Challenges

The present disclosure is intended to solve the above-mentioned conventional problems, and aims to provide a socket type PCR cartridge in which the PCR cartridge is located in a direction horizontal to the direction of centrifugal force generated by the rotation of the interface module, such that micro voids are not formed inside the PCR cartridge.

In addition, another purpose of the present disclosure is to provide a socket type PCR cartridge in which the shape of the PCR cartridge is hexahedral so that the PCR cartridge is in close contact with a heating block and the contact area is widened, thereby improving the thermal efficiency during heating.

### Technical Solution

To accomplish the above objectives, a socket type PCR cartridge of the present disclosure includes: a cartridge connecting portion, which is connected to be injected with a DNA mixture solution by centrifugal force and is detachable from either or both of a waste module and an interface module; a cartridge main body portion, one side of which is connected to the cartridge connecting portion, where heating and cooling take place for polymerase chain reaction after the DNA mixture solution is injected; and a valve portion, which is disposed on a top of the cartridge main body portion, and blocks and closes off the cartridge main body portion from the cartridge connecting portion to prevent reflux of the DNA mixture solution when the DNA mixture solution is injected into the cartridge main body portion by centrifugal force.

The cartridge main body portion includes: a conduit portion, which is a passageway connected to the cartridge connecting portion; a blocking portion, which is connected to the conduit portion, and serves as a space where the valve portion moves downward to block the reflux of the DNA mixture solution to the cartridge connecting portion; and a reaction portion, which is connected to the blocking portion, where the DNA mixture solution is injected to be heated by a heating block.

The conduit of the cartridge connecting portion and the conduit of the cartridge main body portion are located on a same straight line, and the conduit of the cartridge connecting portion and the conduit of the cartridge main body portion are located in a direction horizontal to the direction of the centrifugal force by which the DNA mixture solution is injected.

The cartridge main body portion including the reaction portion has a hexahedral shape in the form of an inverted trapezoid for close contact with a heating auxiliary block of the heating block.

The material of the cartridge connecting portion and the cartridge main body portion may be polyethylene, and the material of the valve portion may be polydimethylsiloxane (PDMS).

The rotational real time PCR device of the present disclosure includes a DNA extraction cartridge module, a waste module located at a bottom of the DNA extraction cartridge module, an interface module located at a bottom of the waste module, a PCR cartridge connected to respective side surfaces of the waste module and interface module, and a heating block located at a bottom of the PCR cartridge.

The rotational real time PCR device of the present disclosure includes a DNA extraction cartridge module, an interface module located at a bottom of the DNA extraction cartridge module, a PCR cartridge connected with a side surface of the interface module, and a heating block located at a bottom of the PCR cartridge.

An operation method of a rotational real time PCR device having a socket type PCR cartridge of the present disclosure includes: a first step of preparing a plurality of PCR cartridges by connecting the cartridge connecting portion and the cartridge main body portion; a second step of mounting the plurality of PCR cartridges on the waste module and the interface module; a third step of injecting a DNA mixture solution, which contains DNA separated from the DNA extraction cartridge module and is stirred by centrifugal force while rotating in the interface module, into the PCR cartridge; a fourth step of closing a valve portion of the PCR cartridge when the rotation of the interface module is completed; and a fifth step of seating a reaction portion of the PCR cartridge in a heating auxiliary block to repeatedly heat and cool the reaction portion in order to amplify DNA and test for target DNA.

An operation method of a rotational real time PCR device having a socket type PCR cartridge of the present disclosure includes: a first step of preparing a plurality of PCR cartridges by connecting the cartridge connecting portion and the cartridge main body portion; a second step of mounting the plurality of PCR cartridges on the interface module; a third step of injecting a DNA mixture solution, which contains DNA separated from the DNA extraction cartridge module and is stirred by centrifugal force while rotating in the interface module, into the PCR cartridge; a fourth step of closing a valve portion of the PCR cartridge when the rotation of the interface module is completed; and a fifth step of seating a reaction portion of the PCR cartridge in a heating auxiliary block to repeatedly heat and cool the reaction portion in order to amplify DNA and test for target DNA.

### Effect of Invention

As described above, the present disclosure has an effect of preventing the formation of micro voids because the direction of the PCR cartridge is horizontal, rather than perpendicular, to the direction of centrifugal force caused by the rotation of the interface module.

In addition, the present disclosure has an effect of increasing the heat transfer efficiency due to the hexahedral shape of the PCR cartridge, which is in close contact with the heating block and has a large contact area.

Furthermore, the present disclosure has an effect of enabling the use of cartridge main body portions of various sizes depending on the PCR reaction volumes because the PCR cartridge can be separated into a cartridge connecting portion and a cartridge main body portion.

### BRIEF DESCRIPTION OF THE DRAWINGS

FIG. 1 is a schematic view of a rotational real time PCR device according to one embodiment of the present disclosure.

FIG. 2 is an exploded view of a rotational real time PCR device according to one embodiment of the present disclosure.

FIG. 3A shows that a DNA solution is injected into an interface module according to one embodiment of the present disclosure, and FIG. 3B shows that a discarded solution of a DNA solution is stored in a waste module according to one embodiment of the present disclosure.

FIG. 4 is a schematic view of a heating block according to one embodiment of the present disclosure.

FIG. 5 is a cross-sectional view of a PCR cartridge according to one embodiment of the present disclosure.

FIG. 6 is a cross-sectional view of a cartridge main body portion according to one embodiment of the present disclosure.

FIG. 7A is a schematic view of a socket type PCR cartridge according to one embodiment of the present disclosure, and FIG. 7B is a diagram showing a cartridge connecting portion according to one embodiment of the present disclosure.

FIG. 8 is an exploded view of a PCR cartridge according to another embodiment of the present disclosure.

FIG. 9A is a diagram showing a cartridge main body portion being seated in a heating auxiliary block according to one embodiment of the present disclosure, and FIG. 9B is a diagram showing a cartridge main body portion being seated in a heating auxiliary block according to another embodiment of the present disclosure.

FIG. 10A is a cross-sectional view of a reaction portion according to one embodiment of the present disclosure, and FIG. 10B is a cross-sectional view of a reaction portion according to another embodiment of the present disclosure.

FIG. 11 is a diagram showing a conduit of a socket type PCR cartridge according to one embodiment of the present disclosure.

FIG. 12 is an exploded view of a cartridge main body portion and a valve portion according to one embodiment of the present disclosure.

FIG. 13A is a cross-sectional view showing an open state of a valve portion according to one embodiment of the present disclosure, and FIG. 13B is a cross-sectional view showing a closed state of a valve portion according to one embodiment of the present disclosure.

FIG. 14A is a cross-sectional view showing a closed state of a valve portion according to one embodiment of the present disclosure, and FIG. 14B is a diagram showing a closed state of a valve portion according to one embodiment of the present disclosure as seen from the top of the valve portion.

FIG. 15 shows a valve portion and a blocking portion according to one embodiment of the present disclosure.

FIG. 16 is a flowchart of an operation method of a rotational real time PCR device having a socket type PCR cartridge according to one embodiment of the present disclosure.

### DETAILED DESCRIPTION OF THE EMBODIMENTS

The present disclosure may have various modifications and several embodiments, and specific embodiments are illustrated in the drawings and described in detail in the detailed description. However, this is not intended to limit the present disclosure to the specific embodiments, but should be understood to encompass all modifications, equivalents, or substitutes that fall within the idea and the scope of the present disclosure. In describing each drawing, similar reference numerals are used for similar components.

Terms such as first, second, A, B, and the like may be used to describe various components, but such components should not be limited by such terms. These terms are used for the sole purpose of distinguishing one component from another.

For example, without departing from the scope of the present disclosure, the first component may be named as the second component, and similarly, the second component may also be named as the first component. The term “and/or” includes any combination of a plurality of related described items or any one of a plurality of related described items.

When a component is referred to as being “connected” or “accessed” to another component, it should be understood that it may be directly connected or accessed to that other component, but there may also be other component in between. On the other hand, when a component is referred to as being “directly connected” or “directly accessed” to another component, it should be understood that there is no other component in between.

The terminology used in this application is intended to describe particular embodiments only and is not intended to limit the present disclosure. Singular expressions include plural expressions unless the context explicitly indicates otherwise. In the present application, it should be understood that terms “include” or “have” or the like are intended to specify the presence of a feature, number, step, operation, component, part, or combination thereof described in the specification, but do not exclude in advance the possibility of the presence or addition of one or more other features, numbers, steps, operations, components, parts, or combinations thereof.

Unless otherwise defined, all terms used herein, including technical or scientific terms, have the same meaning as commonly understood by one of ordinary skill in the art to which the present disclosure belongs. Terms defined in commonly used dictionaries should be construed to have meanings consistent with their meaning in the context of the relevant art, and will not be construed in an idealized or overly formal sense unless expressly defined in the present application.

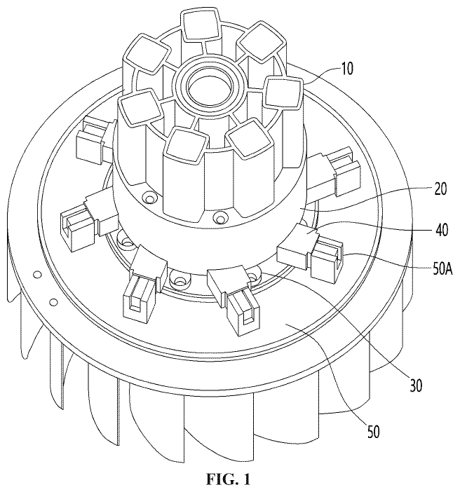

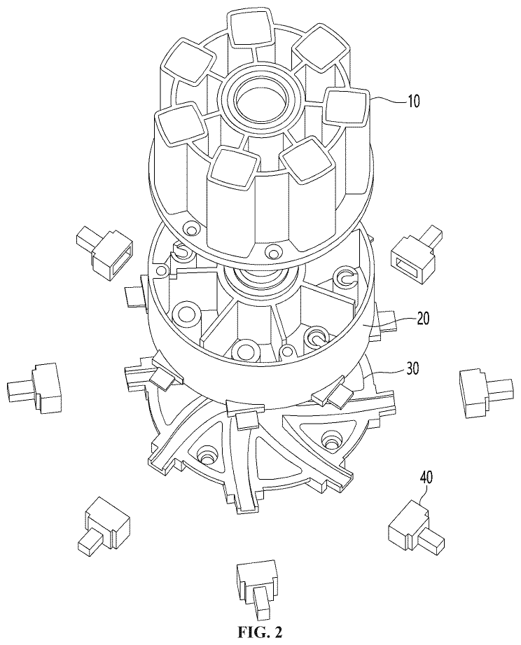

Hereinafter, a rotational real time PCR device having a plurality of socket type PCR cartridges 30 of the present disclosure will be described with reference to the drawings. FIG. 1 is a schematic view of a rotational real time PCR device according to one embodiment of the present disclosure, and FIG. 2 is an exploded view of a rotational real time PCR device according to one embodiment of the present disclosure. Referring to FIG. 1 or FIG. 2, the rotational real time PCR device of the present disclosure may include a DNA extraction cartridge module 10, a waste module 20 located at a bottom of the DNA extraction cartridge module 10, an interface module 30 located at a bottom of the waste module 20, a PCR cartridge 40 connected with respective side surfaces of the waste module 20 and interface module 30, and a heating block 50 located at a bottom of the PCR cartridge 40.

Furthermore, a rotational real time PCR device, which is another embodiment of the present disclosure, may include a DNA extraction cartridge module, an interface module located at a bottom of the DNA extraction cartridge module, a PCR cartridge connected with a side surface of the interface module, and a heating block located at a bottom of the PCR cartridge.

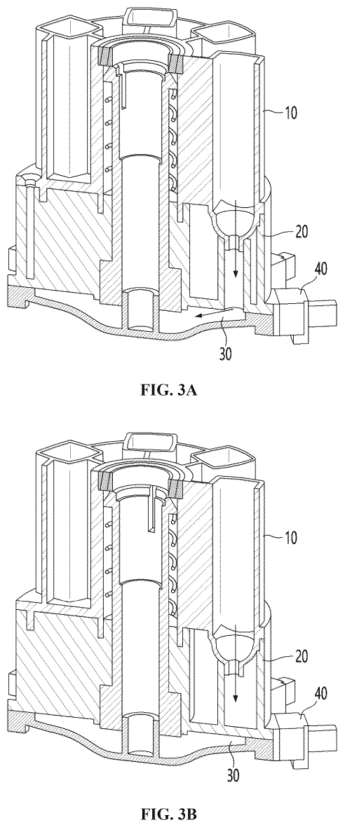

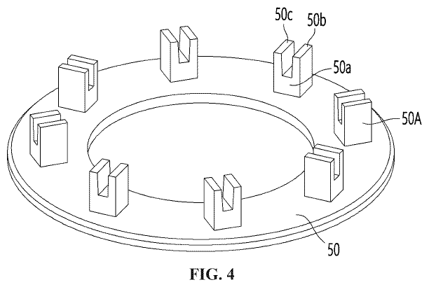

The DNA extraction cartridge module 10 performs the extraction of DNA from cells. The extraction tubes of the DNA cartridge module may include a lysis buffer tube, a magnetic beads tube, a wash buffer tube, and an elution tube. Here, the lysis buffer tube may be treated with a solution containing a substance that dissolves cell walls, and the magnetic beads tube uses magnetic materials, which are dense, magnetic particles that act to break thick cell walls that cannot be chemically broken. The wash buffer tube may wash DNA chains inside the cell, that have passed through the lysis buffer tube and the magnetic beads tube, with distilled water while being attached to magnetic beads, to remove foreign substances such as proteins. The elution tube may demagnetize, allowing DNA to detach from the beads and separate as free particles in solution. FIG. 3A shows that a DNA solution is injected into an interface module 30 according to one embodiment of the present disclosure, and FIG. 3B shows that a discarded solution of the DNA solution is stored in a waste module 20 according to one embodiment of the present disclosure. As shown in FIG. 3A or FIG. 3B, impurities in the DNA extraction cartridge module 10 move to the waste module 20, and the extracted DNA solution moves to the interface module 30. For example, in the waste module 20, which is connected to the lysis buffer tube, the magnetic beads tube, and the wash buffer tube of the DNA extraction cartridge module 10, the solution does not flow into the interface module, and the waste module 20, which is connected to the elution tube of the DNA extraction cartridge module 10, has a conduit connected to the interface module 30 so that the DNA solution flows through the interface module 30 into the PCR cartridge 40. In the interface module 30, the DNA solution stirred with the master mix and mineral oil is divided into a plurality of channels via a separation rod and injected into the individual PCR cartridges 40 by centrifugal force. According to the prior art, a PCR cartridge 40 is located in a direction perpendicular to the direction of centrifugal force generated by the rotation of the interface module 30, such that the centrifugal force generated by the rotation of the interface module 30 may lead to the formation of micro voids inside, preventing the solution from being entirely filled. Micro voids formed inside the PCR cartridge 40 may cause deformation of the fluid or scattering of light due to the expansion of vapor pressure at high temperatures, and therefore the PCR cartridge 40 must be spun down in a centrifuge before PCR loading. FIG. 4 is a schematic view of a heating block according to one embodiment of the present disclosure. Referring to FIG. 4, a heating auxiliary block 50A is located on a top of the heating block 50 of the present disclosure, and when the heating block 50 is heated, heat is transferred to the heating auxiliary block 40A. The heating auxiliary block 40A protrudes from the heating block 50 and forms a space inside for the cartridge main body portion 200 to be inserted. For example, the heating auxiliary block 40A may include a block portion 50a in contact with the heating block 50, a pair of block barrier portions 50b,50c located on a top of the block portion 50a and spaced apart from each other, and the cartridge main body portion 200 may be heated in contact with the block portion 50a and the block barrier portions 50b,50c, thereby increasing the contact area of the cartridge main body portion 200 and improving the heating efficiency.

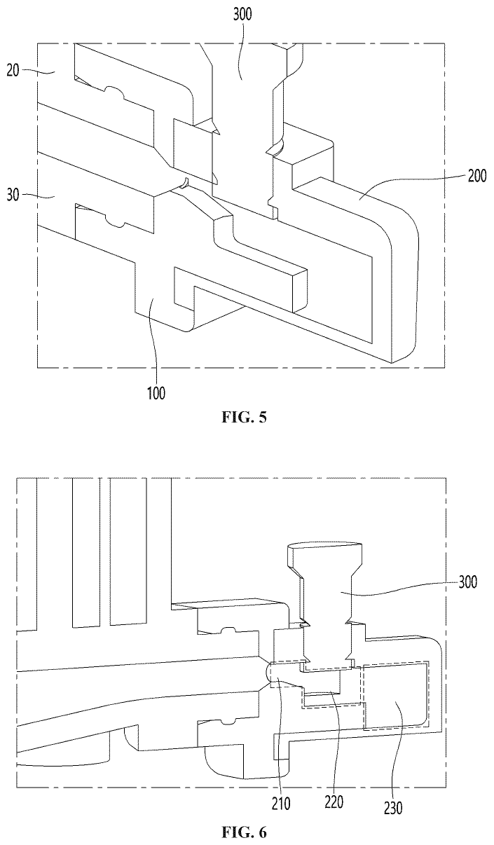

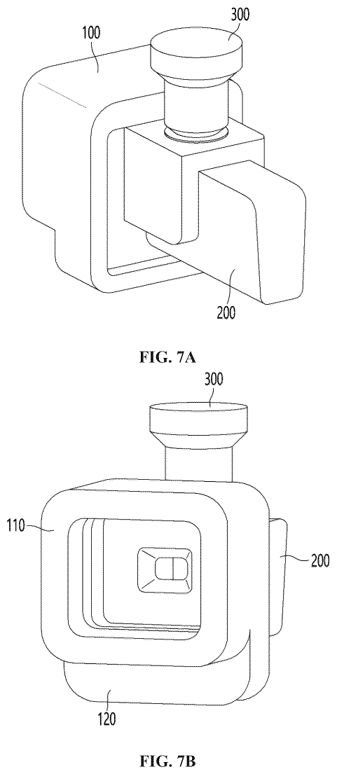

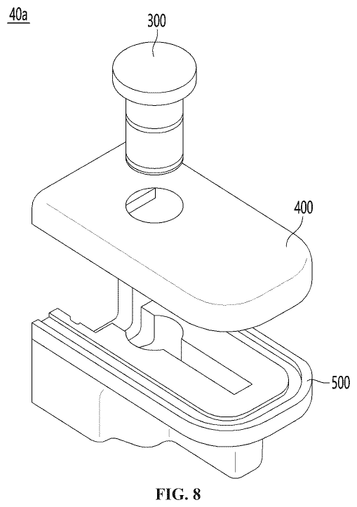

Next, a socket type PCR cartridge 40 of the present disclosure will be described with reference to the drawings. FIG. 5 is a cross-sectional view of a PCR cartridge 40 according to one embodiment of the present disclosure, FIG. 6 is a cross-sectional view of a cartridge main body portion according to one embodiment of the present disclosure, FIG. 7A is a schematic view of a socket type PCR cartridge 40 according to one embodiment of the present disclosure, and FIG. 7B is a diagram showing a cartridge connecting portion 100 according to one embodiment of the present disclosure. Referring to FIG. 5 to FIG. 7, the socket type PCR cartridge 40 of the present disclosure may include a cartridge connecting portion 100, a cartridge main body portion 200, and a valve portion 300.

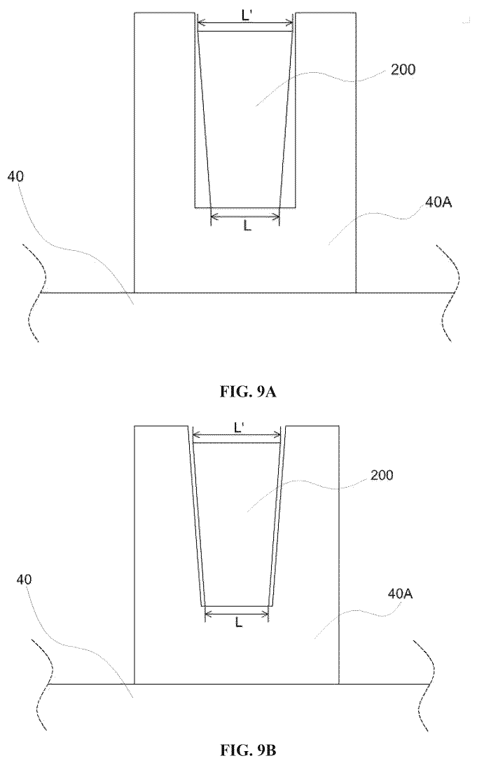

FIG. 8 is an exploded view of a PCR cartridge according to another embodiment of the present disclosure. According to another embodiment, the PCR cartridge 40 of the present disclosure may include a valve portion 300, an upper cartridge 400, and a lower cartridge 500, as shown in FIG. 8. The PCR cartridge 40 of the present disclosure includes an upper cartridge 400, a lower cartridge 500 detachably formed on a bottom of the upper cartridge 400, and a valve portion 300 insertably formed in the upper cartridge 400. The upper cartridge 400 has a top of the cartridge connecting portion and a top of the cartridge main body portion, and the lower cartridge 500 has a bottom of the cartridge connecting portion and a bottom of the cartridge main body portion. Here, the cartridge connecting portion is formed by a coupling of the top of the cartridge connecting portion and the bottom of the cartridge connecting portion, and the cartridge main body portion is formed by a coupling of the top of the cartridge main body portion and the bottom of the cartridge main body portion. The method of fabricating and assembling the parts of the PCR cartridge 40 can be determined by considering the connectivity of the seams of the parts being assembled, the maintenance of airtightness after connection, the stability of the thickness of the side surfaces of the PCR cartridge 40, the optical properties of the front of the cartridge main body portion 200 of the PCR cartridge 40, and the like.

The cartridge connecting portion 100 of the present disclosure has the form of a socket, with the top connected to the waste module 20 and the bottom connected to the interface module 30, and may be detachable from the waste module 20 and the interface module 30, allowing the DNA mixture solution to be injected by centrifugal force of the interface module 30. Because the cartridge connecting portion 100 has the form of a socket, the used PCR cartridge 40 can be separated and removed from the waste module 20 and the interface module 30 and a new PCR cartridge 40 may be attached. The cartridge connecting portion 100 of the present disclosure may include a socket type detachable portion 110 that is detachable from the waste module 20 and the interface module 30, and a connecting conduit portion 120 that is connected to the detachable portion 110 and connected by a conduit to the cartridge main body portion 200. The detachable portion 110 should be sufficiently resilient to attach to and detach from the waste module 20 and interface module 30. The detachable portion 110 should be hermetically connected to the waste module 20 and the interface module 30 to prevent the DNA mixture solution from leaking out. On the other hand, the connecting conduit portion 120 includes a funnel-shaped conduit, and the connecting conduit portion 120 in the direction of the interface module 30 has a wide inlet so that the DNA mixture solution injected by centrifugal force can be collected into the wide inlet. The connecting conduit portion 120 narrows toward the cartridge main body portion 200, thereby generating acceleration, allowing the DNA mixture solution to move through the narrowing conduit to the cartridge main body portion 200.

The cartridge main body portion 200 of the present disclosure is connected on one side to the cartridge connecting portion 100, and the DNA mixture solution is injected by the centrifugal force of the interface module 20, after which the cartridge main body portion 200 is heated or cooled by the heating block 50 for the polymerase chain reaction. Referring to FIG. 6, the cartridge main body portion 200 of the present disclosure includes a conduit portion 210, which is a passageway connected to the cartridge connecting portion 100; a blocking portion 220, which is connected to the conduit portion 210, and serves as a space where the valve portion 300 moves downward to block the reflux of the DNA mixture solution to the cartridge connecting portion 100; and a reaction portion 230, which is connected to the blocking portion 220, where the DNA mixture solution is injected to be heated by a heating block 50. The DNA mixture solution injected through the connecting conduit portion 120 passes through the conduit portion 210, passes through the blocking portion 220, and is injected into the reaction portion 230. When the injection of the DNA mixture solution into the reaction portion 230 is completed, the blocking portion 220 is closed by the valve portion 300 to prevent the DNA mixture solution from refluxing and flowing into the conduit portion 210 and the connecting conduit portion 120.

The cartridge main body portion 200 including the reaction portion 230 of the present disclosure is preferably hexahedral in shape for close contact with the heating auxiliary block 50A of the heating block 50. FIG. 9A is a diagram showing a cartridge main body portion 200 being seated in a heating auxiliary block 50A according to one embodiment of the present disclosure, and FIG. 9B is a diagram showing a cartridge main body portion 200 being seated in a heating auxiliary block 50A according to another embodiment of the present disclosure. Referring to FIG. 9A or FIG. 9B, assuming that the length of one side of the lower surface of the cartridge main body portion 200 is L and the length of one side of the upper surface of the cartridge main body portion 200 is L′, it is preferable that L<L′. In order for the cartridge main body portion 200 to be heated by the heating block 50, it must be firmly seated in the heating auxiliary block 50A, and for this purpose, the cartridge main body portion 200 of the present disclosure may have a hexahedral shape, preferably in the form of an inverted trapezoidal shape with a long upper side and a short lower side. Since the heating auxiliary block 50A has a cuboidal shape inside, it is preferred that the cartridge main body portion 200 is a hexahedron in the form of an inverted trapezoid in order for the cartridge main body portion 200 to be seated in the heating auxiliary block 50A, which is cuboidal. The reason that the shape of the cartridge main body portion 200 is a hexahedron in the form of an inverted trapezoid, rather than a cuboid, is that the length of one side of the bottom of the cartridge main body portion 200 can be shorter than the length of one side of the top, thereby facilitating the insertion of the cartridge main body portion 200 into the heating auxiliary block 50A. For example, if the shape of the cartridge main body portion 200 is a cuboid where the length of one side of the top of the cartridge main body portion 200 is equal to the length of one side of the bottom of the cartridge main body portion 200, it may be difficult to insert and seat the cartridge main body portion 200 into the heating auxiliary block 50A when the position of the cartridge main body portion 200 is slightly offset from the heating auxiliary block 40A. To avoid this problem, the length of one side of the upper surface of the cartridge main body portion 200 can be longer than the length of one side of the lower surface of the cartridge main body portion 200 so that the cartridge main body portion 200 can be easily inserted and seated in the heating auxiliary block 50A.

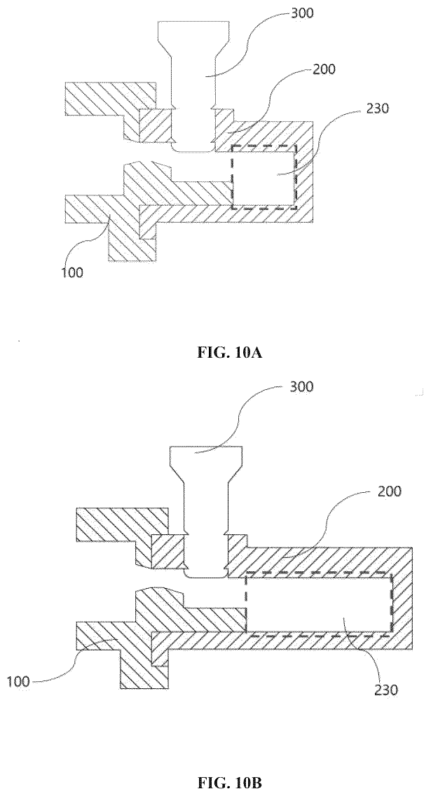

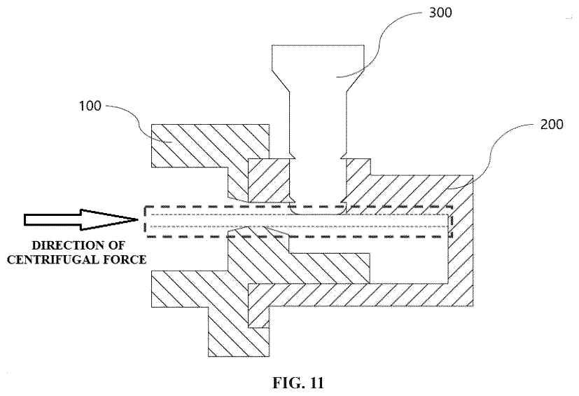

The cartridge connecting portion 100 and the cartridge main body portion 200 of the present disclosure are connectable and detachable, and the capacity of the cartridge main body portion 200 can be changed to change the PCR reaction volumes. FIG. 10A is a cross-sectional view of a reaction portion 230 according to one embodiment of the present disclosure, and FIG. 10B is a cross-sectional view of a reaction portion 230 according to another embodiment of the present disclosure. Referring to FIG. 10A or FIG. 10B, the cartridge connecting portion 100 and the cartridge main body portion 200 are connectable and detachable, and the cartridge main body portion 200 may be used in connection with the cartridge connecting portion 100 by replacing the cartridge main body portion 200 with a cartridge main body portion 200 having a larger or smaller space in the reaction portion 230, where the DNA mixture solution is injected, to change the PCR reaction volumes. FIG. 10A is a cartridge main body portion 200 having a standard capacity cartridge reaction portion 230, and FIG. 10B is a cartridge main body portion 200 having a large capacity cartridge reaction portion 230. As such, the advantage of the present disclosure is that cartridge main body portion 200 can be used in various sizes according to the PCR reaction volumes.

The conduits of the cartridge connecting portion 100 and the cartridge main body portion 200 of the present disclosure are located on a same line, and the conduits of the cartridge connecting portion 100 and the cartridge main body portion 200 are located in a direction horizontal to the direction of centrifugal force by which the DNA mixture solution is injected. FIG. 11 is a diagram showing a conduit of a PCR cartridge 40 according to one embodiment of the present disclosure. As shown in FIG. 11, the conduits of the cartridge connecting portion 100 and the cartridge main body portion 200, through which the DNA mixture solution moves, should be located on a same line so that the DNA mixture solution can move without obstruction. Furthermore, the conduits of the cartridge connecting portion 100 and the cartridge main body portion 200 should be located in the same horizontal direction as the centrifugal force by which the DNA mixture solution is injected, so that the DNA mixture solution can be easily injected into the PCR cartridge 40 by the centrifugal force generated by the rotation of the interface module 30. As described above, the DNA mixture solution injected into the PCR cartridge 40 by centrifugal force may fill the reaction portion 230 with a strong force and speed due to centrifugal force, and micro voids, which can form in the PCR cartridge 40 when the PCR cartridge 40 is located in a direction perpendicular to the direction of centrifugal force, do not form. The present disclosure has an advantage that the PCR cartridge 40 is located in a direction horizontal to the direction of the centrifugal force generated by the rotation of the interface module 30, so that the PCR cartridge 40 is filled with the DNA mixture solution by centrifugal force, and thus no micro voids are formed. Thus, the PCR cartridge 40 of the present disclosure does not require a spin-down process to remove separate micro voids.

It is preferable that the cartridge connecting portion 100 and the cartridge main body portion 200 of the present disclosure be made of polyethylene resin. It is more preferable that the cartridge connecting portion 100 and the cartridge main body portion 200 of the present disclosure use high-density polyethylene, which is translucent and high-density, rather than transparent and soft low-density polyethylene. In particular, great care must be taken when making an outer surface of the reaction portion 230, where light is measured by the camera, from polyethylene to ensure that the surface is even so that the light is not distorted.

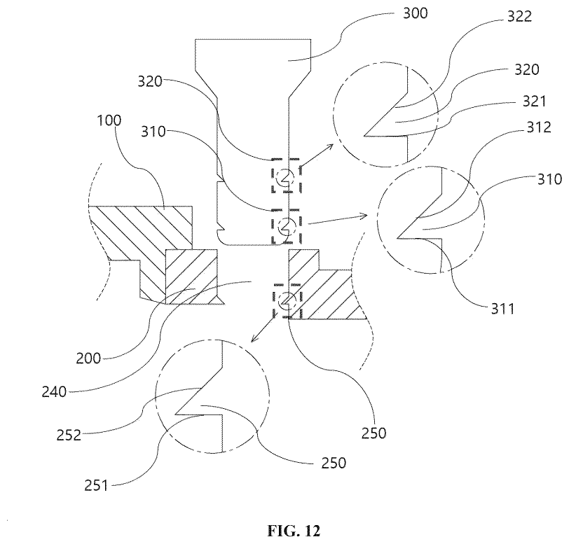

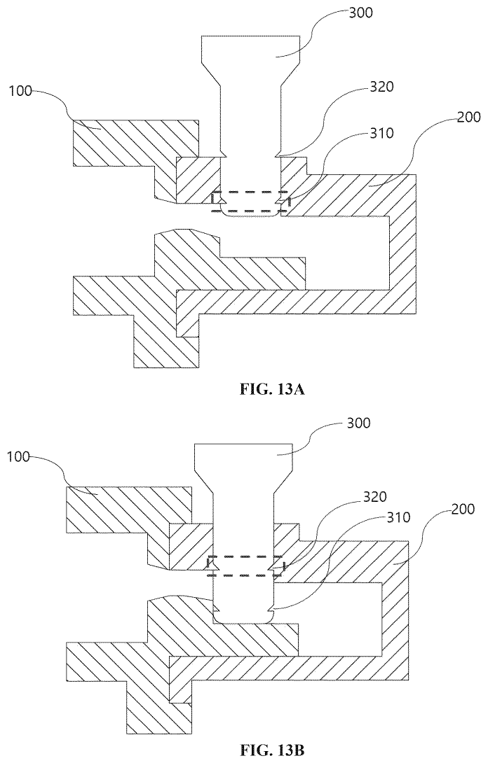

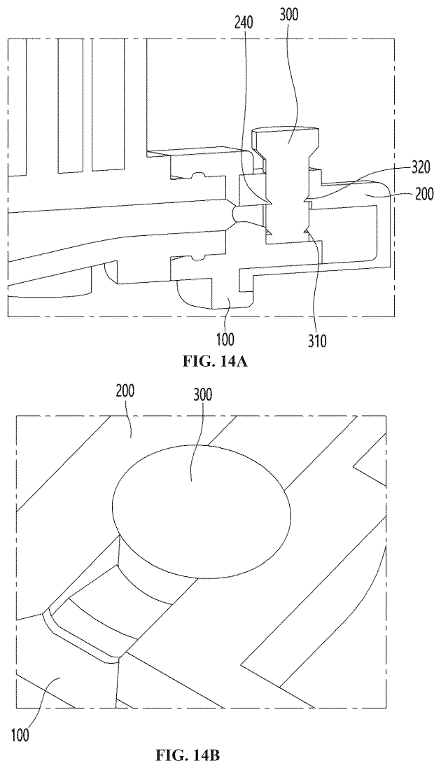

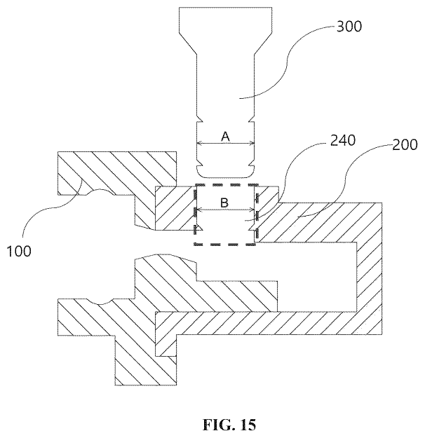

The valve portion 300 of the present disclosure is disposed on the top of the cartridge main body portion 200, and blocks and closes off the cartridge main body portion 200 from the cartridge connecting portion 100 to prevent reflux of the DNA mixture solution when the DNA mixture solution is injected into the cartridge main body portion 200 by centrifugal force. FIG. 12 is an exploded view of a cartridge main body portion and a valve portion according to one embodiment of the present disclosure, FIG. 13A is a cross-sectional view showing an open state of a valve portion according to one embodiment of the present disclosure, FIG. 13B is a cross-sectional view showing a closed state of a valve portion according to one embodiment of the present disclosure, FIG. 14A is a cross-sectional view showing a closed state of a valve portion according to one embodiment of the present disclosure, and FIG. 14B is a diagram showing a closed state of a valve portion according to one embodiment of the present disclosure as seen from the top of the valve portion. Referring to FIGS. 12 to 14, the cartridge main body portion 200 of the present disclosure includes a valve hole 240 on the top for insertion of the valve portion 300, and the cartridge main body portion 200 includes a protrusion 250, which protrudes into the valve hole 240. The protrusion 250 is formed by contacting a horizontal protrusion surface 251, which is a horizontal surface of the protruding surface, and an inclined protrusion surface 252, which is an inclined surface of the protruding surface. The valve portion 300 is insertable into the valve hole 240, and the valve portion 300 has a first groove portion 310 on the inside of the side surface and a second groove portion 320 located on the top of the first groove portion 310. The first groove portion 310 is formed by contacting a first horizontal groove surface 311, which is a horizontal surface of the recessed side, and a first inclined groove surface 312, which is an inclined surface of the recessed side. Furthermore, the second groove portion 320 is formed by contacting a second horizontal groove surface 321, which is a horizontal surface of the recessed side, and a second inclined groove surface 322, which is an inclined surface of the recessed side. The horizontal protrusion surface 251 of the protrusion 250 is in contact with the first horizontal groove surface 311 of the first groove portion 310 or the second horizontal groove surface 321 of the second groove portion 320, and the inclined protrusion surface 252 of the protrusion 250 is in contact with the first inclined groove surface 312 of the first groove portion 310 or the second inclined groove surface 322 of the second groove portion 320, thus fixing the valve portion 300 to the cartridge main body portion 200. Referring to FIG. 13A, when the blocking portion of the cartridge main body portion 200 is in an open state from the valve portion 300, the protrusion 250 of the cartridge main body portion 200 is coupled to the first groove portion 310 of the valve portion 300, thereby fixing the valve portion 300 to the cartridge main body portion 200 in the open state. At this time, the horizontal protrusion surface 251 of the protrusion 250 and the first horizontal groove surface 311 of the first groove portion 310 are in contact, and the inclined protrusion surface 252 of the protrusion 250 and the first inclined groove surface 312 of the first groove portion 310 are in contact. Referring to FIG. 13B, when the blocking portion of the cartridge main body portion 200 is in a closed state by the valve portion 300, the protrusion 250 of the cartridge main body portion 200 is coupled to the second groove portion 320 of the valve portion 300, thereby fixing the valve portion 300 to the cartridge main body portion 200 in the closed state. At this time, the horizontal protrusion surface 251 of the protrusion 250 and the second horizontal groove surface 321 of the second groove portion 320 are in contact, and the inclined protrusion surface 252 of the protrusion 250 and the second inclined groove surface 322 of the second groove portion 320 are in contact. On the top of the valve portion 300 of the present disclosure, a valve operating portion (not shown), which operates the valve portion 300, is located. The valve operating portion is a device that may implement up and down movement by the operation of a drive motor and gear. When closing the valve portion 300, the valve operating portion operates the drive motor and applies pressure to the bottom of the valve portion 300 so that the valve portion 300 is closed. The valve portion 300 is not operated when the interface module 30 is rotating and the DNA mixture solution is being injected into the PCR cartridge 40 by centrifugal force, and when the rotation of the interface module 30 is completed, the valve operating portion is activated to close the valve portion 300 to prevent the DNA mixture solution injected into the reaction portion 230 from refluxing. For the polymerase chain reaction, the valve portion 300 remains closed during the heating and cooling of the cartridge main body portion 200. The material of the valve portion 300 of the present disclosure is preferably polydimethylsiloxane (PDMS). The inert nature of polydimethylsiloxane and its rubber-like properties at low temperatures make it suitable for use in the valve portion 300 of the present disclosure. In other words, the valve portion 300 is preferably made using polydimethylsiloxane because it should not react with the DNA mixture solution while also having elasticity and properties suitable for closing and opening the blocking portion 220. FIG. 15 shows a valve portion and a blocking portion according to one embodiment of the present disclosure. Referring to FIG. 15, if the diameter of the valve of the valve portion 300 is A and the diameter of the valve hole 240 is B, A may be >B, and more preferably, A may be 0.1 to 0.15 mm larger than B. Because the valve portion 300 is made of elastic polydimethylsiloxane, it may be inserted into the valve hole 240 due to its elasticity, even if it is larger than the valve hole 240. The diameter of the valve is larger than that of the valve hole 240, thereby maintaining airtightness and blocking the blocking portion 220 to prevent the DNA mixture solution from refluxing.

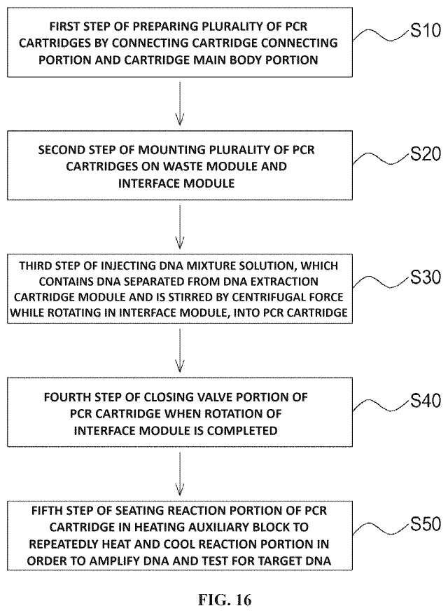

Hereinafter, an operation method of a rotational real time PCR device having a socket type PCR cartridge 40 of the present disclosure will be described with reference to the drawings. FIG. 16 is a flowchart of an operation method of a rotational real time PCR device having a socket type PCR cartridge 40 according to one embodiment of the present disclosure. Referring to FIG. 16, the operation method of a rotational real time PCR device having a socket type PCR cartridge 40 of the present disclosure may include the following five steps.
First step S10: preparing a plurality of PCR cartridges 40 by connecting a cartridge connecting portion 100 and a cartridge main body portion 200
Second step S20: mounting the plurality of PCR cartridges 40 on a waste module 20 and an interface module 30
Third step S30: injecting a DNA mixture solution, which contains DNA separated from the DNA extraction cartridge module 10 and is stirred by centrifugal force while rotating in the interface module 30, into the PCR cartridge 40
Fourth step S40: closing the valve portion 300 of the PCR cartridge 40 when the rotation of the interface module 30 is completed
Fifth step S50: seating a reaction portion 230 of the PCR cartridge 40 in a heating auxiliary block 50A to repeatedly heat and cool the reaction portion 230 in order to amplify DNA and test for target DNA

Further, an operation method of a rotational real time PCR device having a socket type PCR cartridge, which is another embodiment of the present disclosure, includes: a first step of preparing a plurality of PCR cartridges by connecting the cartridge connecting portion and the cartridge main body portion; a second step of mounting the plurality of PCR cartridges on the interface module; a third step of injecting a DNA mixture solution, which contains DNA separated from the DNA extraction cartridge module and is stirred by centrifugal force while rotating in the interface module, into the PCR cartridge; a fourth step of closing a valve portion of the PCR cartridge when the rotation of the interface module is completed; and a fifth step of seating a reaction portion of the PCR cartridge in a heating auxiliary block to repeatedly heat and cool the reaction portion in order to amplify DNA and test for target DNA.

The first step of the operation method of a real time PCR device having a socket type PCR cartridge 40 of the present disclosure involves preparing a plurality of PCR cartridges 40 by connecting a cartridge connecting portion 100 and a cartridge main body portion 200. Typically, eight PCR cartridges 40 may be prepared. A cartridge main body portion 200 having various capacities depending on the PCR reaction volumes may be used, and a plurality of PCR cartridges 40 are prepared by assembling the cartridge connecting portion 100 and the cartridge main body portion 200.

The second step of the operation method of a real time PCR device having a socket type PCR cartridge 40 of the present disclosure involves mounting the plurality of PCR cartridges 40 on a waste module 20 and an interface module 30. Since the cartridge connecting portion 100 has the form of a socket, the PCR cartridge 40 may be easily mounted on the waste module 20 and the interface module 30.

The third step of the operation method of a real time PCR device having a socket type PCR cartridge 40 of the present disclosure involves injecting a DNA mixture solution, which contains DNA separated from the DNA extraction cartridge module 10 and is stirred by centrifugal force while rotating in the interface module 30, into the PCR cartridge 40. The cells prepared in the DNA extraction cartridge module 10 may be treated with a solution containing a substance that dissolves the cell wall with the lysis buffer tube, the magnetic beads tube may break the cell wall with dense particles that are magnetic, and the wash buffer tube may wash DNA chains inside the cell, that have passed through the lysis buffer tube and the magnetic beads tube, with distilled water while being attached to magnetic beads, to remove foreign substances such as proteins. Then, the elution tubes may demagnetize, allowing DNA to detach from the beads and separate as free particles in solution. Impurities in the DNA extraction cartridge module 10 move to the waste module 20, and the extracted DNA solution moves to the interface module 30. The DNA solution stirred with the master mix and mineral oil is divided into a plurality of channels via a separation rod and injected into the individual PCR cartridges 40 by centrifugal force.

The fourth step of the operation method of a real time PCR device having a socket type PCR cartridge 40 of the present disclosure involves closing a valve portion 300 of the PCR cartridge 40 so that the DNA mixture solution, injected into the reaction portion 230 after the rotation of the interface module is completed, does not reflux toward the interface module 30. Since the conduits of the cartridge connecting portion 100 and the cartridge main body portion 200 are located in a direction horizontal to the direction of centrifugal force caused by the rotation of the interface module 30, the DNA mixture solution may reflux through the conduits of the cartridge connecting portion 100 and the cartridge main body portion 200. To prevent this, a valve portion 300 may be provided, and the valve portion 300 may be closed when the rotation of the interface module 30 is completed so that the injected DNA mixture solution can be stored in the reaction portion 230.

The fifth step of the operation method of a real time PCR device having a socket type PCR cartridge 40 of the present disclosure involves seating a reaction portion 230 of the PCR cartridge 40 in a heating auxiliary block 50A to repeatedly heat and cool the reaction portion 230 in order to amplify DNA and test for target DNA. In this step, the reaction portion 230 is heated to 92° C. to 95° C. to separate double-stranded DNA into single-stranded DNA. After that, the primers bind to the DNA with complementary base sequences to their own base sequences, and the desired section of the DNA is amplified to detect the target DNA.

The present disclosure is not limited to the above embodiments, but may be made in a variety of different forms, and those having ordinary skill in the art to which the present disclosure belongs will understand that the present disclosure may be practiced in other specific forms without altering the technical idea or essential features of the invention. Therefore, the embodiments described above are exemplary in all aspects and should be understood as non-limiting.

1. A socket type PCR cartridge, comprising:
a cartridge connecting portion, which is connected to be injected with a DNA mixture solution by centrifugal force and is detachable;
a cartridge main body portion, one side of which is connected to the cartridge connecting portion, where heating and cooling take place for polymerase chain reaction after the DNA mixture solution is injected; and
a valve portion, which is disposed on a top of the cartridge main body portion, and blocks and closes off the cartridge main body portion from the cartridge connecting portion to prevent reflux of the DNA mixture solution when the DNA mixture solution is injected into the cartridge main body portion by centrifugal force.

2. The socket type PCR cartridge of claim 1, wherein the cartridge main body portion comprises: a conduit portion, which is a passageway connected to the cartridge connecting portion; a blocking portion, which is connected to the conduit portion, and serves as a space where the valve portion moves downward to block the reflux of the DNA mixture solution to the cartridge connecting portion; and a reaction portion, which is connected to the blocking portion, where the DNA mixture solution is injected to be heated by a heating block.

3. The socket type PCR cartridge of claim 1, wherein the conduit of the cartridge connecting portion and the conduit of the cartridge main body portion are located on a same straight line, and the conduit of the cartridge connecting portion and the conduit of the cartridge main body portion are located in a direction horizontal to the direction of the centrifugal force through which the DNA mixture solution is injected.

4. The socket type PCR cartridge of claim 1, wherein the cartridge main body portion comprising the reaction portion has a inverted trapezoidal hexahedral shape for close contact with a heating auxiliary block of the heating block.

5. The socket type PCR cartridge of claim 1, wherein the material of the cartridge connecting portion and the cartridge main body portion is polyethylene, and the material of the valve portion is polydimethylsiloxane (PDMS).

6. A rotational real time PCR device having a plurality of socket type PCR cartridges of any of claim 1, comprising:
a DNA extraction cartridge module, a waste module located at a bottom of the DNA extraction cartridge module, an interface module located at a bottom of the waste module, a PCR cartridge connected to respective side surfaces of the waste module and interface module, and a heating block located at a bottom of the PCR cartridge.

7. An operation method of the rotational real time PCR device having a socket type PCR cartridge of claim 6, comprising:
a first step of preparing a plurality of PCR cartridges by connecting the cartridge connecting portion and the cartridge main body portion;
a second step of mounting the plurality of PCR cartridges on the waste module and the interface module;
a third step of injecting a DNA mixture solution, which contains DNA separated from the DNA extraction cartridge module and is stirred by centrifugal force while rotating in the interface module, into the PCR cartridge;
a fourth step of closing a valve portion of the PCR cartridge when the rotation of the interface module is completed; and
a fifth step of seating a reaction portion of the PCR cartridge in a heating auxiliary block to repeatedly heat and cool the reaction portion in order to amplify DNA and test for target DNA.

8. A rotational real time PCR device having a plurality of socket type PCR cartridges of claim 2, comprising:
a DNA extraction cartridge module, a waste module located at a bottom of the DNA extraction cartridge module, an interface module located at a bottom of the waste module, a PCR cartridge connected to respective side surfaces of the waste module and interface module, and a heating block located at a bottom of the PCR cartridge.

9. A rotational real time PCR device having a plurality of socket type PCR cartridges of claim 3, comprising:
a DNA extraction cartridge module, a waste module located at a bottom of the DNA extraction cartridge module, an interface module located at a bottom of the waste module, a PCR cartridge connected to respective side surfaces of the waste module and interface module, and a heating block located at a bottom of the PCR cartridge.

10. A rotational real time PCR device having a plurality of socket type PCR cartridges of claim 4, comprising:
a DNA extraction cartridge module, a waste module located at a bottom of the DNA extraction cartridge module, an interface module located at a bottom of the waste module, a PCR cartridge connected to respective side surfaces of the waste module and interface module, and a heating block located at a bottom of the PCR cartridge.

11. A rotational real time PCR device having a plurality of socket type PCR cartridges of claim 5, comprising:
a DNA extraction cartridge module, a waste module located at a bottom of the DNA extraction cartridge module, an interface module located at a bottom of the waste module, a PCR cartridge connected to respective side surfaces of the waste module and interface module, and a heating block located at a bottom of the PCR cartridge.

12. An operation method of the rotational real time PCR device having a socket type PCR cartridge of claim 8, comprising:
a first step of preparing a plurality of PCR cartridges by connecting the cartridge connecting portion and the cartridge main body portion;
a second step of mounting the plurality of PCR cartridges on the waste module and the interface module;
a third step of injecting a DNA mixture solution, which contains DNA separated from the DNA extraction cartridge module and is stirred by centrifugal force while rotating in the interface module, into the PCR cartridge;
a fourth step of closing a valve portion of the PCR cartridge when the rotation of the interface module is completed; and
a fifth step of seating a reaction portion of the PCR cartridge in a heating auxiliary block to repeatedly heat and cool the reaction portion in order to amplify DNA and test for target DNA.

13. An operation method of the rotational real time PCR device having a socket type PCR cartridge of claim 9, comprising:
a first step of preparing a plurality of PCR cartridges by connecting the cartridge connecting portion and the cartridge main body portion;
a second step of mounting the plurality of PCR cartridges on the waste module and the interface module;
a third step of injecting a DNA mixture solution, which contains DNA separated from the DNA extraction cartridge module and is stirred by centrifugal force while rotating in the interface module, into the PCR cartridge;
a fourth step of closing a valve portion of the PCR cartridge when the rotation of the interface module is completed; and
a fifth step of seating a reaction portion of the PCR cartridge in a heating auxiliary block to repeatedly heat and cool the reaction portion in order to amplify DNA and test for target DNA.

14. An operation method of the rotational real time PCR device having a socket type PCR cartridge of claim 10, comprising:
a first step of preparing a plurality of PCR cartridges by connecting the cartridge connecting portion and the cartridge main body portion;
a second step of mounting the plurality of PCR cartridges on the waste module and the interface module;
a third step of injecting a DNA mixture solution, which contains DNA separated from the DNA extraction cartridge module and is stirred by centrifugal force while rotating in the interface module, into the PCR cartridge;
a fourth step of closing a valve portion of the PCR cartridge when the rotation of the interface module is completed; and
a fifth step of seating a reaction portion of the PCR cartridge in a heating auxiliary block to repeatedly heat and cool the reaction portion in order to amplify DNA and test for target DNA.

15. An operation method of the rotational real time PCR device having a socket type PCR cartridge of claim 11, comprising:
a first step of preparing a plurality of PCR cartridges by connecting the cartridge connecting portion and the cartridge main body portion;
a second step of mounting the plurality of PCR cartridges on the waste module and the interface module;
a third step of injecting a DNA mixture solution, which contains DNA separated from the DNA extraction cartridge module and is stirred by centrifugal force while rotating in the interface module, into the PCR cartridge;
a fourth step of closing a valve portion of the PCR cartridge when the rotation of the interface module is completed; and
a fifth step of seating a reaction portion of the PCR cartridge in a heating auxiliary block to repeatedly heat and cool the reaction portion in order to amplify DNA and test for target DNA.
